(19) United States
(12) Patent Application Publication
(10) Pub. No.: US 2023/0252645 A1
(43) Pub. Date: Aug. 10, 2023

(54) VASCULAR PLAQUE EXTRACTION APPARATUS AND METHOD

(71) Applicant: GE Precision Healthcare LLC, Wauwatosa, WI (US)

(72) Inventors: Wenjia Wang, Beijing (CN); Yingbin Nie, Guangzhou (CN); Chen Zhang, Guangzhou (CN); Yige Li, Beijing (CN)

(21) Appl. No.: 18/160,870

(22) Filed: Jan. 27, 2023

(30) Foreign Application Priority Data
Jan. 29, 2022 (CN) 202210111238.6

(51) Int. Cl. G06T 7/187; G06T 7/11; G06V 10/44

(52) U.S. Cl. CPC G06T 7/187; G06T 7/11; G06V 10/44; G06T 2207/10081; G06T 2207/20081; G06T 2207/30101

(57) ABSTRACT

Embodiments of the present application provide a vascular plaque extraction apparatus and method. The method includes: acquiring a computed tomography angiography (CTA) image; performing preprocessing on the CTA image; performing a vascular lumen segmentation on the preprocessed CTA image to obtain a vascular lumen image; performing a dilation operation on the vascular lumen image to obtain a dilated region of interest (ROI), and performing a voxel-based radiomics feature extraction on the dilated ROI to obtain at least one voxel feature map; and extracting vascular plaques based on a preset threshold corresponding to the at least one voxel feature map and the at least one voxel feature map. According to the embodiments of the present application, the vascular plaques can be quickly and accurately extracted from the CTA image, providing a reference for an accurate quantitative analysis and auxiliary diagnosis and treatment.

### CROSS-REFERENCE TO RELATED APPLICATIONS

This application claims priority to Chinese Application No. 202210111238.6, filed on Jan. 29, 2022, the disclosure of which is incorporated herein by reference in its entirety.

### TECHNICAL FIELD

Embodiments of the present application relate to the technical field of medical devices, in particular to a vascular plaque extraction apparatus and method.

### BACKGROUND

Coronary artery disease (CAD) is the most common type of cardiovascular disease. Coronary artery stenosis is a major cause of coronary heart disease, typically caused by coronary atherosclerotic plaques. Coronary computed tomography angiography (CCTA, simply referred to as coronary CT angiography) is a computed tomography technique of coronary angiography. After injection of contrast agent, a CT scan is performed, and then scan data is collected, processed and reconstructed by a computer, and finally a corresponding three-dimensional image of coronary arteries of the heart is obtained. It is a non-invasive and economical and efficient examination method and is widely used in clinical practice.

CCTA can provide accurate coronary artery anatomical information and contribute to determine a stenosis state. Its advantages include cost-effectiveness, non-invasiveness, and relatively high spatial resolution. In addition to providing accurate information on the degree of lumen stenosis, due to high spatial resolution thereof, plaque morphology and rich relevant feature details in the lumen can be further displayed. Accurate extraction and quantitative analysis of plaques on the CCTA is crucial for the diagnosis and treatment of CAD patients.

It should be noted that the above description of the background is only for the convenience of clearly and completely describing the technical solutions of the present application, and for the convenience of understanding of those skilled in the art.

### SUMMARY

However, the inventor finds that accurate extraction of vascular plaques in a CCTA image is still a challenging problem. At present, most of the existing plaque extraction methods are based on different Hounsfield unit (HU) values on CT images, but the accuracy of extracting plaques by these methods needs to be improved. For a calcified plaque, the presence of an artifact may result in an overestimation or underestimation of a plaque area, and an early calcified plaque is difficult to be extracted through a single HU threshold. For a non-calcified plaque, it is difficult to distinguish a fibrotic plaque and a lipid plaque by the HU threshold due to a very small tissue composition difference of a soft plaque. Another challenge is the extraction of a mixed plaque due to complex components thereof and border with similar intensity to an extravascular border.

A recent trend is to perform a more thorough evaluation of plaques by using advanced imaging techniques to evaluate relevant risks. For example, magnetic resonance imaging (MRI) has high contrast resolution and sensitivity, and can identify high-risk plaque features. In addition, ultrasonic contrast is also a powerful tool to evaluate the susceptibility of a carotid artery plaque. Nevertheless, CCTA examination still has certain advantages in the clinical workflow. The extraction of vascular plaques from CCTA is of great significance for the evaluation of coronary heart disease.

To extract the vascular plaques from the CCTA image, the embodiments of the present application provide a vascular plaque extraction apparatus and method. It is expected that the vascular plaques can be quickly and accurately extracted from the CCTA image, providing a reference for an accurate quantitative analysis and auxiliary diagnosis and treatment.

According to an aspect of the embodiments of the present application, a vascular plaque extraction apparatus is provided. The apparatus includes an image acquisition unit, acquiring a computed tomography angiography (CTA) image, an image preprocessing unit, performing preprocessing on the CTA image, a vascular lumen segmentation unit, performing a segmentation on the preprocessed CTA image to obtain a vascular lumen image, a feature extraction unit, performing a dilation operation on the vascular lumen image to obtain a dilated region of interest (ROI), and performing a voxel-based radiomics feature extraction on the dilated ROI to obtain at least one voxel feature map, and a vascular plaque extraction unit, extracting vascular plaques based on a preset threshold corresponding to the at least one voxel feature map and the at least one voxel feature map.

In some embodiments, the vascular lumen segmentation unit uses a deep learning network to segment the preprocessed CTA image.

In some embodiments, the vascular lumen segmentation unit further uses a region growing algorithm and/or a bilateral threshold optimization method to perform optimization processing on the vascular lumen image, obtain an optimized vascular lumen image, and provide the optimized vascular lumen image to the feature extraction unit, so that the feature extraction unit performs a dilation operation on the optimized vascular lumen image.

In some embodiments, the vascular plaque extraction unit uses a voxel within a threshold range on the at least one voxel feature map as a potential plaque, and uses an intersection of the potential plaque and the vascular lumen image as the vascular plaque.

In some embodiments, the vascular plaque extraction unit further uses a region growing algorithm to perform optimization processing on the extracted vascular plaque to obtain a final vascular plaque.

In some embodiments, the at least one voxel feature map includes a first-order feature voxel feature map, a second-order feature voxel feature map and/or a higher-order feature voxel feature map.

In some embodiments, first-order features of the first-order feature voxel feature map include one of the following: energy, total energy, entropy, minimum, 10th percentile, 90th percentile, maximum, mean, median, interquartile range, range, mean absolute deviation, robust mean absolute deviation, root mean square, standard deviation, skewness, kurtosis, variance, and uniformity.

According to another aspect of the embodiments of the present application, a vascular plaque extraction method is provided. The method includes acquiring a computed tomography angiography (CTA) image, performing preprocessing on the CTA image, performing a vascular lumen segmentation on the preprocessed CTA image to obtain a vascular lumen image, performing a dilation operation on the vascular lumen image to obtain a dilated region of interest (ROI), and performing a voxel-based radiomics feature extraction on the dilated ROI to obtain at least one voxel feature map, and extracting vascular plaques based on a preset threshold corresponding to the at least one voxel feature map and the at least one voxel feature map.

In some embodiments, performing a vascular lumen segmentation on the preprocessed CTA image includes using a deep learning network to segment the preprocessed CTA image.

In some embodiments, the method further includes using a region growing algorithm and/or a bilateral threshold optimization method to perform optimization processing on the vascular lumen image and obtain an optimized vascular lumen image, so that a dilation operation is performed on the optimized vascular lumen image.

In some embodiments, extracting vascular plaques includes using a voxel within a threshold range on the at least one voxel feature map as a potential plaque, and using an intersection of the potential plaque and the vascular lumen image as the vascular plaque.

In some embodiments, the method further includes using a region growing algorithm to perform optimization processing on the extracted vascular plaque to obtain a final vascular plaque.

In some embodiments, the at least one voxel feature map includes a first-order feature voxel feature map, a second-order feature voxel feature map and/or a higher-order feature voxel feature map.

In some embodiments, first-order features of the first-order feature voxel feature map include one of the following: energy, total energy, entropy, minimum, 10th percentile, 90th percentile, maximum, mean, median, interquartile range, range, mean absolute deviation, robust mean absolute deviation, root mean square, standard deviation, skewness, kurtosis, variance, and uniformity.

According to another aspect of the embodiments of the present application, an electronic device is provided and includes a memory and a processor, the memory storing a computer program, and the processor being configured to execute the computer program so as to implement the above-mentioned vascular plaque extraction method.

One of the beneficial effects of the embodiments of the present application is that according to the embodiments of the present application, compared to a conventional single-intensity threshold-based method, the vascular plaques can be quickly and accurately extracted from the CTA image, which is of great significance to an automatic quantitative analysis of the vascular plaques, contributing to the diagnosis of vascular stenosis, and providing a reference for a subsequent clinical treatment.

With reference to the following description and accompanying drawings, specific implementations of the embodiments of the present application are disclosed in detail, and manners in which the principle of the embodiments of the present application is employed are illustrated. It should be understood that the implementations of the present application are not thereby limited in scope. Within the spirit and scope of the appended claims, the implementations of the present application comprise various changes, modifications, and equivalents.

### BRIEF DESCRIPTION OF THE DRAWINGS

The accompanying drawings are included to provide further understanding of embodiments of the present application, constitute a part of the specification, and are used to illustrate implementations of the present application and set forth the principles of the present application together with textual description. Obviously, the accompanying drawings in the following description are merely some embodiments of the present application, and a person of ordinary skill in the art may obtain other implementations according to the accompanying drawings without the exercise of inventive effort. In the accompanying drawings:

FIG. 1 is a schematic diagram of a CT imaging device according to an embodiment of the present application;

FIG. 2 is a schematic diagram of a CT imaging system according to an embodiment of the present application;

FIG. 3 is a schematic diagram of a vascular plaque extraction method according to an embodiment of the present application;

FIG. 4 is a schematic diagram of an original CCTA image and a preprocessed CCTA image;

FIG. 5 is a schematic diagram of a coronary artery vascular lumen image (i.e., a coronary artery vascular lumen segmentation result);

FIG. 6 is a schematic diagram of a voxel feature map of uniformity;

FIG. 7 is a schematic diagram of some examples of a first-order feature voxel feature map;

FIG. 8 is a schematic diagram of other examples of a first-order feature voxel feature map;

FIG. 9 is a schematic diagram of an example of vascular plaques extracted by using voxel features of uniformity;

FIG. 10 is a schematic diagram of some examples of vascular plaques extracted by using voxel feature maps of other first-order features;

FIG. 11 is a schematic diagram of one example of extracting vascular plaques from a CCTA image;

FIG. 12 is a schematic diagram of another example of extracting vascular plaques from a CCTA image;

FIG. 13 is a schematic diagram of a vascular plaque extraction apparatus according to an embodiment of the present application; and

FIG. 14 is a schematic diagram of an electronic device according to an embodiment of the present application.

### DETAILED DESCRIPTION

The foregoing and other features of the embodiments of the present application will become apparent from the following description with reference to the accompanying drawings. In the description and the accompanying drawings, specific implementations of the present application are specifically disclosed, and part of the implementations in which the principles of the embodiments of the present application may be employed are indicated. It should be understood that the present application is not limited to the described implementations. On the contrary, the embodiments of the present application include all modifications, variations, and equivalents falling within the scope of the appended claims.

In the embodiments of the present application, the terms “first”, “second”, etc. are used to distinguish different elements, but do not represent a spatial arrangement or temporal order etc. of these elements, and these elements should not be limited by these terms. The terms “and/or” and “/” include any one of and all combinations of one or more of the associated listed terms. The terms “comprise”, “include”, “have”, etc. refer to the presence of described features, elements, components, or assemblies, but do not exclude the presence or addition of one or more other features, elements, components, or assemblies.

In the embodiments of the present application, the singular forms “a”, “the”, etc. include plural forms, and should be broadly construed as “a type of” or “a class of” rather than limited to the meaning of “one.” Furthermore, the term “said” should be construed as including both the singular and plural forms, unless otherwise specified in the context. In addition, the term “according to” should be construed as “at least in part according to . . . ”, and the term “based on” should be construed as “at least in part based on . . . ”, unless otherwise specified in the context.

The features described and/or illustrated for one implementation may be used in one or more other implementations in the same or similar manner, combined with features in other implementations, or replace features in other implementations. The term “include/comprise” when used herein refers to the presence of features, integrated components, steps, or assemblies, but does not preclude the presence or addition of one or more other features, integrated components, steps, or assemblies.

The device described herein for obtaining medical image data may be applicable to a computed tomography (CT) device. The system for obtaining medical imaging data may include the aforementioned medical imaging device, and may include a separate computer device connected to the medical imaging device, and may further include a computer device connected to an Internet cloud, which is connected via the Internet to the medical imaging device or a memory for storing medical images. An imaging method may be independently or jointly implemented by the aforementioned medical imaging device, the computer device connected to the medical imaging device, and the computer device connected to the Internet cloud.

As an example, the embodiments of the present application are described below in conjunction with an X-ray computed tomography (CT) device. Those skilled in the art will appreciate that the embodiments of the present application may further be applicable to other medical imaging devices.

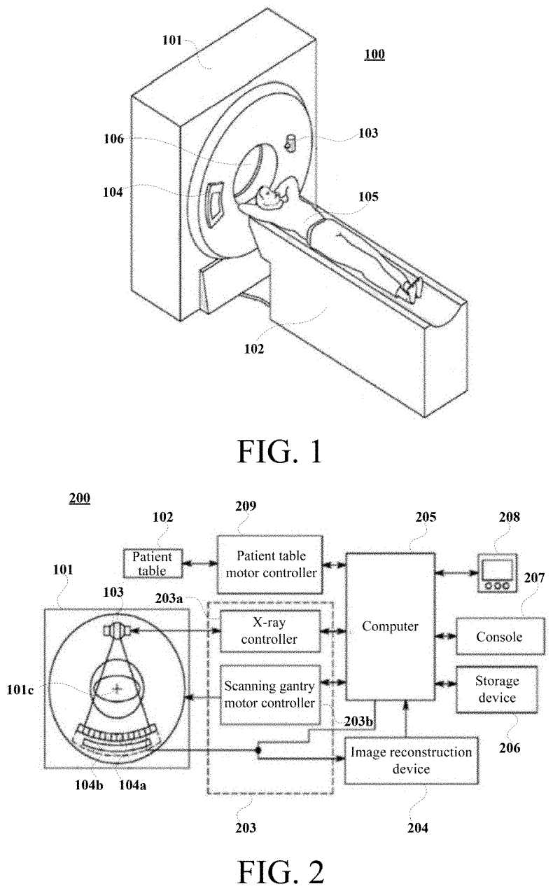

FIG. 1 is a schematic diagram of a CT imaging device according to an embodiment of the present application, schematically showing a situation of the CT imaging device 100. As shown in FIG. 1, the CT imaging device 100 includes a scanning gantry 101 and a patient table 102. The scanning gantry 101 has an X-ray source 103, and the X-ray source 103 projects an X-ray beam towards a detector assembly or a collimator 104 on an opposite side of the scanning gantry 101. A test object 105 can lie flat on the patient table 102 and be moved into a scanning gantry opening 106 along with the patient table 102. Medical image data of the test object 105 can be acquired by means of a scan carried out by the X-ray source 103.

FIG. 2 is a schematic diagram of a CT imaging system according to an embodiment of the present application, schematically showing a block diagram of the CT imaging system 200. As shown in FIG. 2, the detector assembly 104 includes a plurality of detector units 104a and a data acquisition system (DAS) 104b. The plurality of detector units 104a sense a projected X-ray passing through a test object 105.

The DAS 104b converts, according to the sensing of the detector units 104a, collected information into projection data for subsequent processing. During the scanning for acquiring the X-ray projection data, the scanning gantry 101 and components mounted thereon rotate around a rotation center 101c.

The rotation of the scanning gantry 101 and the operation of the X-ray source 103 are controlled by a control mechanism 203 of the CT imaging system 200. The control mechanism 203 includes an X-ray controller 203a that provides power and a timing signal to the X-ray source 103 and a scanning gantry motor controller 203b that controls the rotation speed and position of the scanning gantry 101. An image reconstruction device 204 receives the projection data from the DAS 104b and performs image reconstruction. A reconstructed image is transmitted as an input to a computer 205, and the computer 205 stores the image in a mass storage device 206.

The computer 205 also receives commands and scanning parameters from an operator by means of a console 207. The console 207 has an operator interface in a certain form, such as a keyboard, a mouse, a voice activated controller, or any other suitable input apparatus. An associated display 208 allows the operator to observe the reconstructed image and other data from the computer 205. The commands and parameters provided by the operator are used by the computer 205 to provide control signals and information to the DAS 104b, the X-ray controller 203a, and the scanning gantry motor controller 203b. Additionally, the computer 205 operates a patient table motor controller 209 used to control the patient table 102 so as to position the test object 105 and the scanning gantry 101. Particularly, the patient table 102 moves the test object 105 in whole or in part to pass through the scanning gantry opening 106 in FIG. 1.

The above schematically illustrates the device and system for obtaining medical image data (or also referred to as a medical image or medical image data) according to the embodiments of the present application, but the present application is not limited thereto. The medical imaging device may be a CT device, or any other suitable imaging devices. A storage device may be located within the medical imaging device, in a server outside the medical imaging device, in an independent medical image storage system (such as, a picture archiving and communication system (PACS)), and/or in a remote cloud storage system.

In addition, the medical imaging workstation may be disposed locally at the medical imaging device, that is, the medical imaging workstation is disposed adjacent to the medical imaging device, and the two may both be located in a scanning room, a medical imaging department, or the same hospital. A medical image cloud platform analysis system may be located far away from the medical imaging device. For example, the medical image cloud platform analysis system can be disposed in a cloud terminal communicating with the medical imaging device.

As an example, after a medical institution completes an imaging scan using the medical imaging device, scan data is stored in the storage device. The medical imaging workstation may directly read the scan data and perform image processing by means of a processor thereof. As another example, the medical image cloud platform analysis system may read a medical image in the storage device by means of remote communication to provide “software as a service (SAAS).” SAAS can exist between hospitals, between a hospital and an imaging center, or between a hospital and a third-party online diagnosis and treatment service provider.

The medical image scanning device and system is schematically illustrated above, and the embodiments of the present application are described in detail below with reference to the accompanying drawings.

In the following description, the vascular plaque extraction apparatus and method in the embodiments of the present application are described by using coronary artery CTA (computed tomography angiography) images as an example, but the present application is not limited thereto. The apparatus and method of the embodiments of the present application are also applicable to the extraction of vascular plaques on other arterial CTA images, for example, a cerebral artery CTA image, a carotid artery CTA image, or the like.

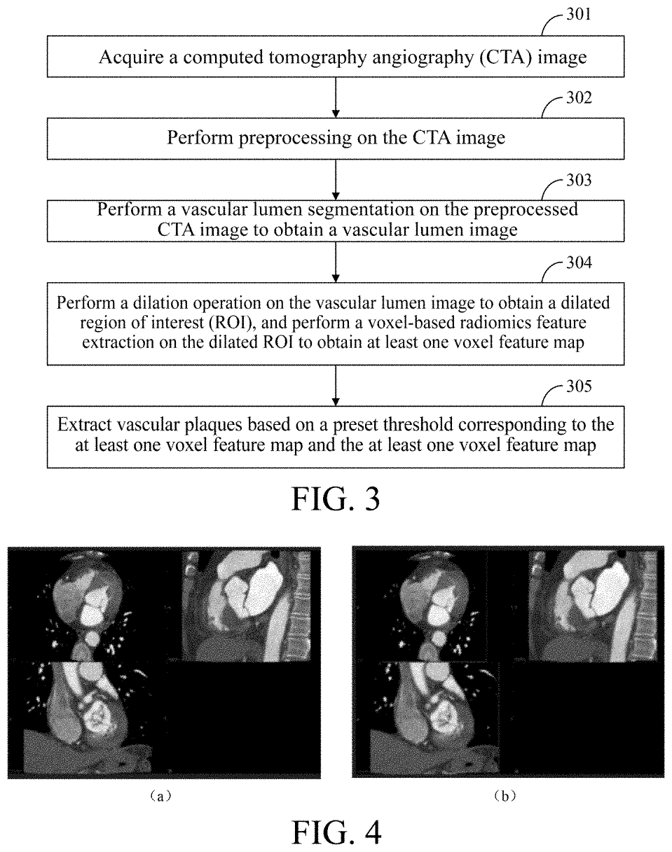

An embodiment of the present application provides a vascular plaque extraction method. FIG. 3 is a schematic diagram of a vascular plaque extraction method according to an embodiment of the present application. As shown in FIG. 3, the method includes:
301: acquiring a computed tomography angiography (CTA) image;
302: performing preprocessing on the CTA image;
303: performing a vascular lumen segmentation on the preprocessed CTA image to obtain a vascular lumen image;
304: performing a dilation operation on the vascular lumen image to obtain a dilated region of interest (ROI), and performing a voxel-based radiomics feature extraction on the dilated ROI to obtain at least one voxel feature map;
305: extracting vascular plaques (i.e., determining a potential area of the vascular plaque) based on a preset threshold corresponding to the at least one voxel feature map and the at least one voxel feature map.

It should be noted that FIG. 3 merely schematically illustrates the embodiment of the present application, but the present application is not limited thereto. For example, the order of execution between operations may be suitably adjusted. In addition, some other operations may also be added or some of these operations may be omitted. Those skilled in the art may make appropriate variations according to the above disclosure, rather than being limited by the disclosure of FIG. 3.

According to the method in the embodiments of the present application, the vascular plaques can be quickly and accurately extracted from the CTA image. The plaque detection result is not directly used for the diagnosis of vascular stenosis, but is used as an intermediate result combined with other information for diagnosis, which contributes to the diagnosis of vascular stenosis, and provides a reference for a subsequent clinical treatment.

In the embodiment of the present application, in 301, the CTA image acquisition includes patient positioning, ECG (electrocardiography) trigger apparatus installation, contrast agent injection, image acquisition and reconstruction, image storage and transmission from CT equipment to a post-processing workstation, and the like. The present application does not limit the specific acquisition process and method, and reference may be made to related technologies.

In the embodiment of the present application, the CTA image may be a coronary artery CTA image, but the present application is not limited thereto, and the CTA image may also be a CTA image of other body parts, for example, a cerebral artery CTA image, a carotid artery CTA image, or the like. For ease of description, the embodiment of the present application uses a coronary artery CTA (CCTA) image as an example for description.

In the embodiment of the present application, the CTA image may be acquired during diastole, and the acquired CTA image is a CTA image of diastole, or the CTA image may be acquired during systole, and the acquired CTA image is a CTA image of systole.

In the embodiment of the present application, various types of CT scanners can be used to acquire the CTA images, for example, a 64-row CT device, or a greater than 64-row CT device. For example, the CT scanner or the CT device may be the CT imaging device 100 shown in FIG. 1, having the configuration of the CT imaging system 200 shown in FIG. 2, the contents of which are incorporated herein, and details are not described herein again.

In the embodiment of the present application, in 302, the image preprocessing includes operations such as clipping, resampling, denoising, and/or edge enhancement on the input CTA image. For example, if the input CTA image includes other objects or background noise, a three-dimensional clipping operation may be performed on the input CTA image. In another example, the clipped image may be linearly interpolated through a resampling operation, so that the voxel of the image is changed to a required size, such as 0.5×0.5×0.5. In another example, an operation of applying a low-pass filter (such as Gaussian filtering) may also be performed on the resampled image to smooth the noise of the image.

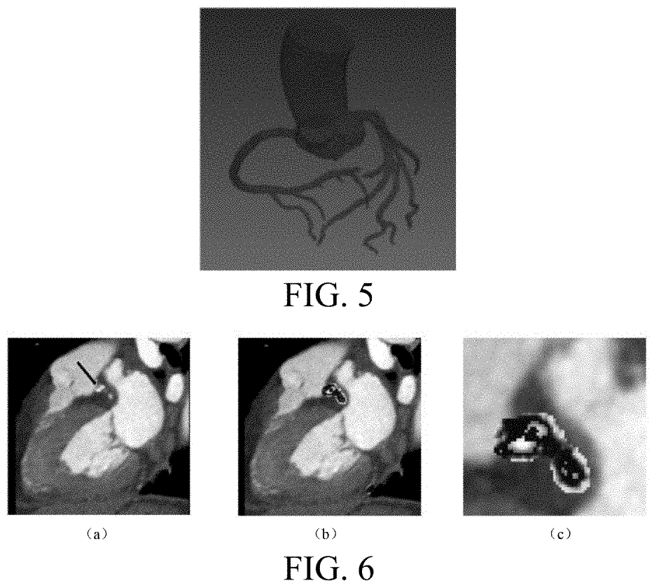

FIG. 4 is a schematic diagram of an original CCTA image and a preprocessed CCTA image. As shown in FIG. 4, (a) is an original CCTA image, by preprocessing (for example, Gaussian filtering) the original CCTA image to obtain the preprocessed CCTA image shown in (b), and the preprocessed CCTA image rejects noise points in the original CCTA image as shown in (a) of FIG. 4.

In the embodiment of the present application, in 303, a deep learning network may be used to perform a vascular lumen segmentation on the preprocessed CTA image, to obtain a vascular lumen segmentation result, i.e., a vascular lumen image. The present application does not limit the type of the deep learning network, for example, the deep learning network may be a Dense V-Net, a nnUNet, or the like.

In some embodiments, a region growing algorithm and/or a bilateral threshold optimization method may further be used to perform optimization processing on the foregoing vascular lumen segmentation result, i.e., the vascular lumen image, to obtain an optimized vascular lumen image, so that a dilation operation is performed on the optimized vascular lumen image. For example, a seed point is selected for the foregoing vascular lumen segmentation result, the region growing algorithm is used to remove the separated noise points, and the bilateral threshold optimization method is used to obtain the optimized vascular lumen image. FIG. 5 is a schematic diagram of an optimized coronary artery vascular lumen segmentation result. The specific implementation of the region growing algorithm and the bilateral threshold optimization method is not limited in the present application, which can refer to related technologies, and the description is omitted herein.

In the foregoing embodiment, the description is made by using the deep learning network to perform a vascular lumen segmentation on the preprocessed CTA image (i.e., to extract the vascular lumen image), and the present application is not limited thereto, and other ways may also be used to perform the vascular lumen segmentation on the preprocessed CTA image, for example, using a manual method or conventional segmentation method to perform the vascular lumen segmentation.

In the embodiment of the present application, in 304, the voxel-based radiomics feature extraction (i.e., computing a voxel feature map) can be performed on the dilated ROI to obtain a voxel feature map.

In some embodiments of the present application, by performing the dilatation operation on the vascular lumen image obtained in 303 to obtain the dilated ROI, and by performing the voxel-based radiomics feature extraction on the dilated ROI rather than performing the voxel-based radiomics feature extraction on the entire image, the calculation time is saved.

It should be noted that the dilation operation belongs to a morphological operation, and is a process of merging a part of background points in contact with the object into the object. The result of the dilation operation increases the area of the object by a corresponding number of points.

In some embodiments, the voxel feature map of the first-order features may be selected to extract the vascular plaques, or the voxel feature map of the second-order features or the voxel feature map of the higher-order features may be selected to extract the vascular plaques. The following uses the voxel feature map of the first-order features as an example.

In the foregoing embodiments, there is no limitation on the type of the first-order features. The first-order features may be any first-order feature in radiomics feature, for example, energy, total energy, entropy, minimum, 10th percentile, 90th percentile, maximum, mean, median, interquartile range, range, mean absolute deviation, robust mean absolute deviation, root mean square, standard deviation, skewness, kurtosis, variance, and uniformity.

FIG. 6 is a schematic diagram of an example of a voxel feature map of uniformity extracted from an input CCTA image in a sagittal plane. (a) is the voxel feature map of uniformity, and (b) and (c) shows a case in which a part of the voxel feature map is enlarged. As shown in FIG. 6, uniformity is a measure of the sum of squares of each intensity value, which is a measure of the uniformity of an image array, where greater uniformity means greater uniformity or smaller range of discrete intensity values, and the feature can reflect differences between the vascular plaque and the vascular lumen. The vascular plaque extraction by using the voxel feature map of uniformity can provide a reference for an arterial stenosis analysis and/or a quantitative analysis of the vascular plaques.

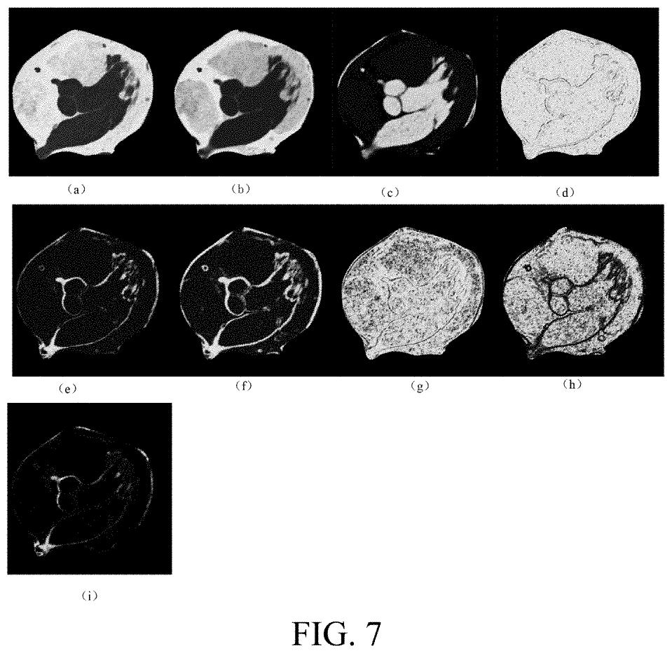

FIG. 7 is a schematic diagram of another example of a voxel feature map of (a) maximum, (b) mean, (c) energy, (d) skewness, (e) mean absolute deviation, (f) range, (g) entropy, (h) uniformity, and (i) variance features extracted from an input CCTA image in a cross section.

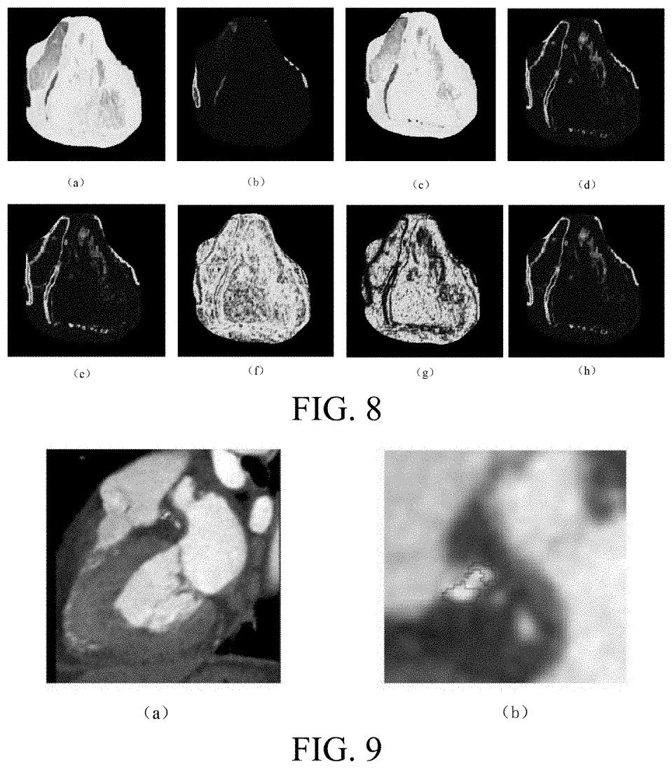

FIG. 8 is a schematic diagram of still another example of a voxel feature map of (a) mean, (b) energy, (c) maximum, (d) robust mean absolute deviation, (e) range, (f) entropy, (g) uniformity, and (h) mean absolute deviation features extracted from an input CCTA image in a sagittal plane.

In the embodiment of the present application, in 305, vascular plaques can be extracted by using a preset threshold corresponding to the extracted voxel feature map.

In some embodiments, the threshold has a single global threshold based on a grayscale histogram of the extracted voxel feature map. The extracted voxel feature map being a voxel feature map of uniformity is still used as an example. Since the uniformity feature value reflects the degree of region non-uniformity, the embodiment of the present application takes an aortic blood pool as a reference, and a threshold of a specific ratio is selected to extract a potential vascular plaque (i.e., a potential area of the vascular plaque).

In some embodiments, a voxel within a threshold range on the at least one voxel feature map (for example, a voxel less than a threshold corresponding to the voxel feature map, or a voxel greater than a threshold corresponding to the voxel feature map) may be used as a potential plaque, and an intersection of the potential plaque and the vascular lumen image is used as the vascular plaque. Due to the dilation operation on the vascular lumen image in the process of extracting the voxel feature map, some pixels considered to be plaques may exceed the range of the vascular lumen, and by taking the intersection of the potential plaque and the vascular lumen image, the misjudgment can be eliminated and plaques outside the vascular lumen can be excluded.

In some embodiments, a region growing algorithm may further be used to perform post-processing on the extracted vascular plaque to obtain a final vascular plaque. Since the plaque grows adhering to the wall and has a physiological feature of adherent growth, by using the region growing algorithm to process the extracted vascular plaque, the extraction accuracy of the plaque can be further improved, and a precise boundary of the plaque can be obtained.

FIG. 9 is a schematic diagram of vascular plaques extracted by using a voxel feature map of uniformity, where (a) is the vascular plaque image, and (b) shows a case in which the vascular plaque is partially enlarged.

In the foregoing embodiments, the voxel-based radiomics feature is used for the vascular plaque extraction, fully utilizing non-uniformity information of the vascular plaque (or information of other first-order features), accurately distinguishing the vascular lumen and the vascular plaque.

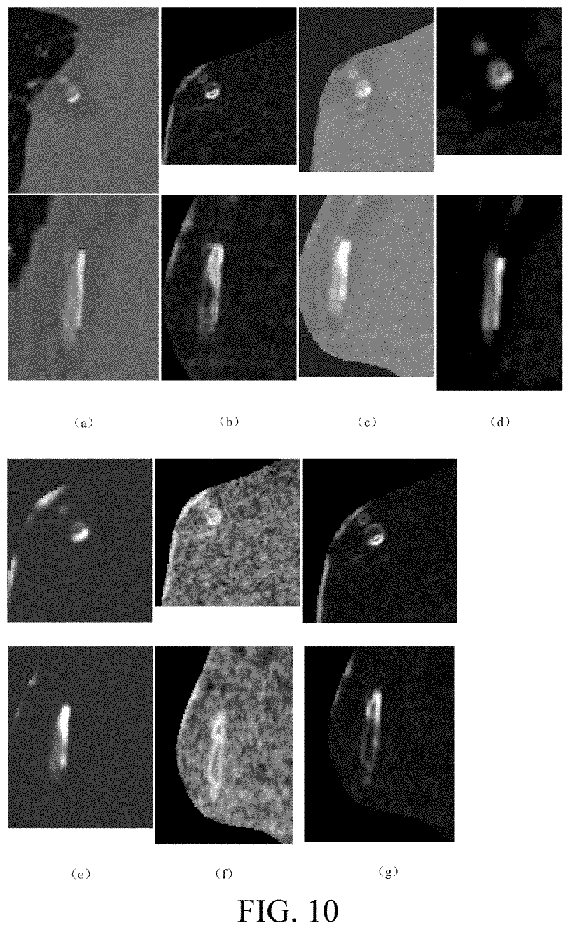

FIG. 10 is a schematic diagram of vascular plaques extracted by using a voxel feature map of other first-order features. As shown in FIG. 10, (a) is a schematic diagram of an original image, (b) is a schematic diagram of extracting vascular plaques by using a range voxel feature map, (c) is a schematic diagram of extracting vascular plaques by using a maximum voxel feature map, (d) is a schematic diagram of extracting vascular plaques by using a mean voxel feature map, (e) a schematic diagram of extracting vascular plaques by using an energy voxel feature map, (f) is a schematic diagram of extracting vascular plaques by using an entropy voxel feature map, and (g) is a schematic diagram of extracting vascular plaques by using a mean absolute deviation voxel feature map.

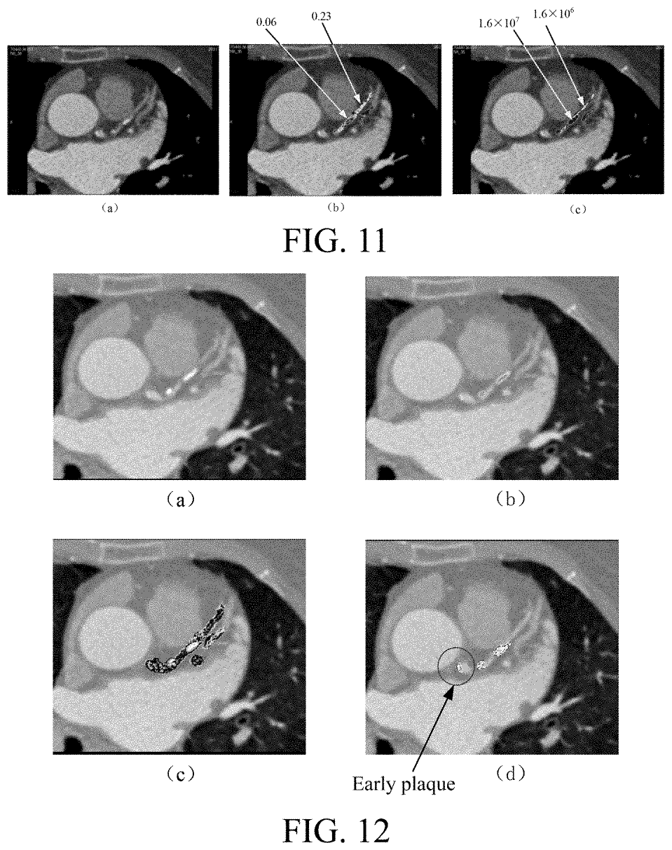

FIG. 11 is a schematic diagram of one example of extracting vascular plaques from a CCTA image. As shown in FIG. 11, (a) is an extracted voxel feature map, (b) is a schematic diagram of vascular plaque extraction by using a uniformity threshold, and (c) is a schematic diagram of vascular plaque extraction by using an energy threshold.

As shown in (b), an example in which the uniformity threshold is 0.1 is used, since 0.06 is less than 0.1, and 0.23 is greater than 0.1, a voxel (pixel point) of 0.06 is used as a vascular plaque. As shown in (c), an example in which the capability threshold is 1.6×5×10⁶ is used, since 1.6×10⁷ is greater than 1.6×5×10⁶, and 1.6×10⁶ is less than 1.6×5×10⁶, a voxel (pixel point) greater than 1.6×5×10⁶ is used as a vascular plaque.

According to the method in the embodiment of the present application, the extraction of vascular plaques from the CCTA image is of great significance for the evaluation of coronary heart disease. Compared to a conventional single-intensity threshold-based method, the vascular plaques can be quickly and accurately extracted from the CCTA image in the method in the embodiments of the present application. In addition, the method in the embodiments of the present application is of great significance to an automatic quantitative analysis of the vascular plaques, contributing to the diagnosis of vascular stenosis, and providing a reference for a subsequent clinical treatment.

FIG. 12 is a schematic diagram of another example of extracting vascular plaques from a CCTA image. As shown in FIG. 12, (a) is an original image, (b) is a schematic diagram of vascular plaques extracted by using a method using an existing Hu threshold, (c) is a schematic diagram of a voxel feature map of uniformity extracted on a dilated ROI by a method according to an embodiment of the present application, and (d) is a schematic diagram of vascular plaques extracted from a voxel feature map of uniformity by using a uniformity threshold.

The following table is an extraction performance comparison result of 49 manually labeled CCTA plaques. As shown in Table 1, no matter what type of plaque is extracted according to the method of the embodiment of the present application, the performance is significantly higher than the method using the existing Hu threshold.

TABLE 1

| Plaque | Dice at Hu | Dice used with the method in the |
|---|---|---|
| category | Threshold | embodiment of the present application |
| Calcified plaque | 0.51 | 0.71 |
| Soft plaque | 0.41 | 0.54 |
| Mixed plaque | 0.3 | 0.56 |

In the foregoing table, “Dice” is an evaluation coefficient, the meaning of which can refer to related technologies, and the description is omitted herein.

The above embodiments merely provide illustrative description of the embodiments of the present application. However, the present application is not limited thereto, and appropriate variations may be made on the basis of the above embodiments. For example, each of the above embodiments may be used independently, or one or more of the above embodiments may be combined.

According to the embodiments of the present application, the vascular plaques can be quickly and accurately extracted from the CTA image, providing a reference for an accurate quantitative analysis and auxiliary diagnosis and treatment.

An embodiment of the present application provides a vascular plaque extraction apparatus, and the same contents as in the embodiment of the first aspect are not repeated herein.

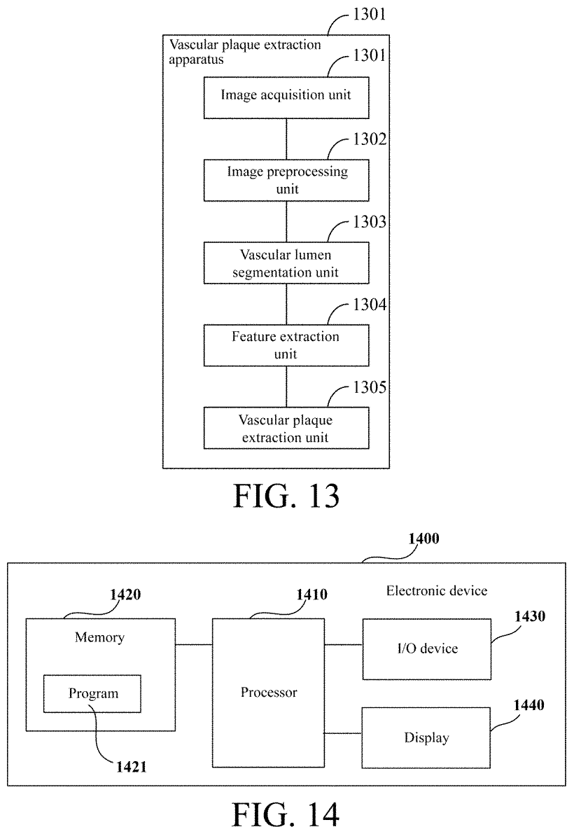

FIG. 13 is a schematic diagram of a vascular plaque extraction apparatus according to an embodiment of the present application. As shown in FIG. 13, the vascular plaque extraction apparatus 1300 in the embodiment of the present application includes:

an image acquisition unit 1301, acquiring a computed tomography angiography (CTA) image;

an image preprocessing unit 1302, performing preprocessing on the CTA image;

a vascular lumen segmentation unit 1303, performing a segmentation on the preprocessed CTA image to obtain a vascular lumen image;

a feature extraction unit 1304, performing a dilation operation on the vascular lumen image to obtain a dilated region of interest (ROI), and performing a voxel-based radiomics feature extraction on the dilated ROI to obtain at least one voxel feature map; and

a vascular plaque extraction unit 1305, extracting vascular plaques based on a preset threshold corresponding to the at least one voxel feature map and the at least one voxel feature map.

In some embodiments, the vascular lumen segmentation unit 1303 uses a deep learning network to segment the preprocessed CTA image.

In some embodiments, the vascular lumen segmentation unit 1303 further uses a region growing algorithm and/or a bilateral threshold optimization method to perform optimization processing on the vascular lumen image, obtain an optimized vascular lumen image, and provide the optimized vascular lumen image to the feature extraction unit, so that the feature extraction unit performs a dilation operation on the optimized vascular lumen image.

In some embodiments, the vascular plaque extraction unit 1305 uses a voxel within a threshold range on the at least one voxel feature map as a potential plaque, and uses an intersection of the potential plaque and the vascular lumen image as the vascular plaque.

In some embodiments, the vascular plaque extraction unit 1305 further uses a region growing algorithm to perform optimization processing on the extracted vascular plaque to obtain a final vascular plaque.

In some embodiments, the at least one voxel feature map includes: a first-order feature voxel feature map, a second-order feature voxel feature map and/or a higher-order feature voxel feature map.

In the foregoing embodiments, the first-order features of the first-order feature voxel feature map include one of the following: energy, total energy, entropy, minimum, 10th percentile, 90th percentile, maximum, mean, median, interquartile range, range, mean absolute deviation, robust mean absolute deviation, root mean square, standard deviation, skewness, kurtosis, variance, and uniformity.

For the sake of simplicity, FIG. 13 only exemplarily illustrates a connection relationship or signal direction between various components or modules, but it should be clear to those skilled in the art that various related technologies such as bus connection can be used. The various components or modules can be implemented by means of a hardware facility such as a processor, a memory, etc. The embodiments of the present application are not limited thereto.

The above embodiments merely provide illustrative description of the embodiments of the present application. However, the present application is not limited thereto, and appropriate variations may be made on the basis of the above embodiments. For example, each of the above embodiments may be used independently, or one or more of the above embodiments may be combined.

According to the embodiments of the present application, the vascular plaques can be quickly and accurately extracted from the CTA image, providing a reference for an accurate quantitative analysis and auxiliary diagnosis and treatment.

An embodiment of the present application provides an electronic device, including the vascular plaque extraction apparatus 1300 according to the embodiment of the second aspect, and the content thereof is incorporated herein. The electronic device may, for example, be a computer, a server, a workstation, a laptop, a smart phone, etc., but the embodiments of the present application are not limited thereto.

FIG. 14 is a schematic diagram of an electronic device according to an embodiment of the present application. As shown in FIG. 14, the electronic device 1400 may include: one or more processors (for example, a central processing unit (CPU)) 1410; and one or more memories 1420 coupled to the one or more processors 1410. The memory 1420 can store various data, further stores a program 1421 for information processing, and executes the program 1421 under control of the processor 1410.

In some embodiments, functions of the vascular plaque extraction apparatus 1300 are integrated into and implemented by the processor 1410. The processor 1410 is configured to implement the vascular plaque extraction method according to the embodiment of the first aspect.

In some embodiments, the vascular plaque extraction apparatus 1300 and the processor 1410 are configured separately, for example, the vascular plaque extraction apparatus 1300 can be configured as a chip connected to the processor 1410 and the functions of the vascular plaque extraction apparatus 1300 can be achieved by means of the control of the processor 1410.

For example, the processor 1410 is configured to control the following operations: acquiring a computed tomography angiography (CTA) image; performing preprocessing on the CTA image; performing a vascular lumen segmentation on the preprocessed CTA image to obtain a vascular lumen image; performing a dilation operation on the vascular lumen image to obtain a dilated region of interest (ROI), and performing a voxel-based radiomics feature extraction on the dilated ROI to obtain at least one voxel feature map; and extracting vascular plaques based on a preset threshold corresponding to the at least one voxel feature map and the at least one voxel feature map.

In addition, as shown in FIG. 14, the electronic device 1400 may further include: an input/output (I/O) device 1430, a display 1440, and the like. Functions of the above components are similar to those in the prior art, and details are not described herein again. It should be noted that the electronic device 1400 does not necessarily include all of the components shown in FIG. 14. In addition, the electronic device 1400 may further include components not shown in FIG. 14, for which reference may be made to the related technologies.

An embodiment of the present application further provides a computer-readable program, where when the program is executed in an electronic device, the program causes a computer to execute, in the electronic device, the vascular plaque extraction method according to the embodiment of the first aspect.

An embodiment of the present application further provides a storage medium storing a computer-readable program, where the computer-readable program causes a computer to execute, in an electronic device, the vascular plaque extraction method according to the embodiment of the first aspect.

The above apparatus and method of the present application can be implemented by hardware, or can be implemented by hardware in combination with software. The present application relates to such a computer-readable program, when executed by a logical component, causes the logical component to implement the foregoing apparatus or constituent part, or causes the logical component to implement various methods or steps as described above. The present application further relates to a storage medium for storing the above program, such as a hard disk, a magnetic disk, an optical disk, a DVD, a flash memory, etc.

The method/apparatus described with reference to the embodiments of the present application may be directly embodied as hardware, a software module executed by a processor, or a combination of the two. For example, one or more of the functional block diagrams and/or one or more combinations of the functional block diagrams shown in the drawings may correspond to either respective software modules or respective hardware modules of a computer program flow. These software modules may respectively correspond to the steps shown in the figures. These hardware modules can be implemented, for example, by firming the software modules using a field-programmable gate array (FPGA).

The software modules may be located in a RAM, a flash memory, a ROM, an EPROM, an EEPROM, a register, a hard disk, a portable storage disk, a CD-ROM, or any storage medium in other forms known in the art. A storage medium may be coupled to a processor, so that the processor can read information from the storage medium and can write information into the storage medium. Alternatively, the storage medium may be a component of the processor. The processor and the storage medium may be located in an ASIC. The software module may be stored in a memory of a mobile terminal, and may also be stored in a memory card that can be inserted into a mobile terminal. For example, if a device (such as a mobile terminal) uses a large-capacity MEGA-SIM card or a large-capacity flash memory device, the software modules can be stored in the MEGA-SIM card or the large-capacity flash memory device.

One or more of the functional blocks and/or one or more combinations of the functional blocks shown in the accompanying drawings may be implemented as a general-purpose processor, a digital signal processor (DSP), an application specific integrated circuit (ASIC), a field-programmable gate array (FPGA) or other programmable logic devices, discrete gate or transistor logic devices, a discrete hardware assembly, or any appropriate combination thereof for implementing the functions described in the present application. The one or more functional blocks and/or the one or more combinations of the functional blocks shown in the accompanying drawings may also be implemented as a combination of computing apparatuses, such as a combination of a DSP and a microprocessor, multiple microprocessors, one or more microprocessors in communication combination with a DSP, or any other such configuration.

The present application is described above with reference to specific implementations. However, it should be clear to those skilled in the art that such description is merely illustrative and is not intended to limit the scope of protection of the present application. Various variations and modifications may be made by those skilled in the art according to the principle of the present application, and these variations and modifications also fall within the scope of the present application.

What is claimed is:

1. A vascular plaque extraction apparatus, characterized by comprising:
an image acquisition unit, acquiring a computed tomography angiography image;
an image preprocessing unit, performing preprocessing on the computed tomography angiography image;
a vascular lumen segmentation unit, performing a segmentation on the preprocessed computed tomography angiography image to obtain a vascular lumen image;
a feature extraction unit, performing a dilation operation on the vascular lumen image to obtain a dilated region of interest, and performing a voxel-based radiomics feature extraction on the dilated region of interest to obtain at least one voxel feature map; and
a vascular plaque extraction unit, extracting vascular plaques based on a preset threshold corresponding to the at least one voxel feature map and the at least one voxel feature map.

2. The apparatus according to claim 1, wherein the vascular lumen segmentation unit uses a deep learning network to segment the preprocessed computed tomography angiography image.

3. The apparatus according to claim 1, wherein the vascular lumen segmentation unit further uses a region growing algorithm and/or a bilateral threshold optimization method to perform optimization processing on the vascular lumen image, obtain an optimized vascular lumen image, and provide the optimized vascular lumen image to the feature extraction unit, so that the feature extraction unit performs a dilation operation on the optimized vascular lumen image.

4. The apparatus according to claim 1, wherein the vascular plaque extraction unit uses a voxel within a threshold range on the at least one voxel feature map as a potential plaque, and uses an intersection of the potential plaque and the vascular lumen image as the vascular plaque.

5. The apparatus according to claim 1, wherein the vascular plaque extraction unit further uses a region growing algorithm to perform optimization processing on the extracted vascular plaque to obtain a final vascular plaque.

6. The apparatus according to claim 1, wherein the at least one voxel feature map comprises: a first-order feature voxel feature map, a second-order feature voxel feature map and/or a higher-order feature voxel feature map.

7. The apparatus according to claim 6, wherein first-order features of the first-order feature voxel feature map comprise one of the following: energy, total energy, entropy, minimum, 10th percentile, 90th percentile, maximum, mean, median, interquartile range, range, mean absolute deviation, robust mean absolute deviation, root mean square, standard deviation, skewness, kurtosis, variance, and uniformity.

8. A vascular plaque extraction method, characterized by comprising:
acquiring a computed tomography angiography image;
performing preprocessing on the computed tomography angiography image;
performing a vascular lumen segmentation on the preprocessed computed tomography angiography image to obtain a vascular lumen image;
performing a dilation operation on the vascular lumen image to obtain a dilated region of interest, and performing a voxel-based radiomics feature extraction on the dilated region of interest to obtain at least one voxel feature map; and
extracting vascular plaques based on a preset threshold corresponding to the at least one voxel feature map and the at least one voxel feature map.

9. The method according to claim 8, wherein the performing a vascular lumen segmentation on the preprocessed computed tomography angiography image comprises:
using a deep learning network to segment the preprocessed computed tomography angiography image.

10. The method according to claim 8, further comprising:
using a region growing algorithm and/or a bilateral threshold optimization method to perform optimization processing on the vascular lumen image and obtain an optimized vascular lumen image, so that a dilation operation is performed on the optimized vascular lumen image.

11. The method according to claim 8, wherein the extracting vascular plaques comprises:
using a voxel within a threshold range on the at least one voxel feature map as a potential plaque, and using an intersection of the potential plaque and the vascular lumen image as the vascular plaque.

12. The method according to claim 8, further comprising:
using a region growing algorithm to perform optimization processing on the extracted vascular plaque to obtain a final vascular plaque.

13. The method according to claim 8, wherein the at least one voxel feature map comprises: a first-order feature voxel feature map, a second-order feature voxel feature map and/or a higher-order feature voxel feature map.

14. The method according to claim 13, wherein first-order features of the first-order feature voxel feature map comprise one of the following: energy, total energy, entropy, minimum, 10th percentile, 90th percentile, maximum, mean, median, interquartile range, range, mean absolute deviation, robust mean absolute deviation, root mean square, standard deviation, skewness, kurtosis, variance, and uniformity.

15. An electronic device, comprising a memory and a processor, the memory having a computer program stored therein, the electronic device being characterized in that: the processor is configured to execute the computer program so as to implement the vascular plaque extraction method according to claim 8.
